(19) United States
(12) Patent Application Publication
(10) Pub. No.: US 2006/0243401 A1
(43) Pub. Date: Nov. 2, 2006

(54) On structure of an actuating mechanism of steel roll-up doors and windows

(76) Inventor: Wei-Ying Chen, Cingshuei Townshop (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/116,218

(22) Filed: Apr. 28, 2005

(51) Int. Cl. E06B 9/56

(52) U.S. Cl. 160/310

(57) ABSTRACT

An actuating mechanism includes a motor, a tube, a transmission, a shank, a worm, a worm wheel, and a spring; the tube has a steel roll-up curtain connected thereto, and can be turned in one direction for winding the curtain around it, and in the other direction for unwinding the curtain; the transmission is joined to an output shaft of the motor and the tube; the shank is joined to a main body of the motor and the worm wheel; the worm has a toothed side for engaging the worm wheel, and it has a straight side facing in an opposite direction to that of the toothed side; the spring is fixed at one end, and securely joined to the transmission at other end; the roll-up curtain can be manually opened and closed without power supply to the motor after the worm is disengaged from the worm wheel.

### BACKGROUND OF THE INVENTION

1. Field of the Invention

The present invention relates to an actuating mechanism of steel roll-up doors and windows, more particularly one, which allows a curtain member of roll-up doors and windows to be rapidly moved with hands when power supply to a motor of the actuating mechanism is faulty or cut off.

2. Brief Description of the Prior Art

Referring to FIGS. 1 and 2, a conventional actuating mechanism 1 of steel roll-up doors and windows includes an electric motor 11, a transmission unit 12, a tube-shaped member 13, a chain 15, a chain disk 16, a worm 17, a worm wheel 18, and a connecting shaft 19. The transmission unit 12 is connected to an output shaft of the electric motor 11 at one end, and the tube-shaped member 13 at the other end. The chain disk 16 is supported in place so as to be capable of turning around an axis thereof. The chain 15 is passed over the chain disk 16 while the worm 17 is securely joined to the axis of the chain disk 16, and engaged with the worm wheel 18. The connecting shaft 19 is securely joined to a main body of the electric motor 11 at one end, and an axis of the worm wheel 18 at the other end. A roll-up door 14 is connected to the tube-shaped member 13 such that the transmission unit 12 and the tube-shaped member 13 will be turned together, and position of the roll-up door 14 will be changed when the electric motor 11 is activated. And, a person is allowed to change the position of the roll-up door 14 by means of pulling the chain 15 to turn the tube-shaped member 13 when power supply to the electric motor 11 is cut off.

The chain disk 16 has a much larger diameter than the worm 17 therefore it takes little force to move the door 14 by means of pulling the chain 15 when power supply to the electric motor 11 is faulty. However, it takes much time to open the door 14 by means of pulling the chain 15. Therefore, the actuating mechanism isn't convenient to use, and casualty is prone to happen in the event of an emergency such as fire because the door 14 can't be rapidly opened with hands.

Referring to FIG. 3, another conventional actuating mechanism 2 of steel roll-up doors and windows includes an electric motor 21, a transmission unit 22, a tube-shaped member 23, a handle 25, a worm 26, a worm wheel 27, and a connecting shaft 28. The transmission unit 22 is connected to an output shaft of the electric motor 21 as well as the tube-shaped member 23. The worm 26 is connected to the handle 25, and engaged with the worm wheel 27. The connecting shaft 28 is securely joined to a main body of the electric motor 21 at one end, and an axis of the worm wheel 27 at the other end. A roll-up door 24 is connected to the tube-shaped member 23 such that the transmission unit 22 and the tube-shaped member 23 will be turned together, and position of the roll-up door 24 will be changed when the electric motor 21 is activated. And, a person is allowed to change the position of the roll-up door 24 by means of operating the handle 25 to cause rotation of the worm 26 and the tube-shaped member 23 when power supply to the electric motor 21 is faulty. However, when the electric motor 21 is cut off, the door 24 can't be rapidly opened by means of operating the handle 25 with hands, and the actuating mechanism 3 isn't convenient to use, either.

### SUMMARY OF THE INVENTION

It is a main object of the invention to provide an improvement on an actuating mechanism of steel roll-up doors and windows to overcome the above-mentioned problem.

The actuating mechanism includes a motor, a tube member, a transmission unit, a connecting shank, a worm, a worm wheel, and an elastic element. The tube member has a steel roll-up curtain connected thereto, and can be turned in one direction for winding the curtain around it, and in the other direction for unwinding the curtain. The transmission unit is joined to an output shaft of the motor and the tube member. The connecting shank is joined to a main body of the motor and the worm wheel. The worm has a toothed side for engaging the worm wheel, and it has a straight side facing in an opposite direction to that of the toothed side. The elastic element is fixed at one end, and securely joined to the transmission unit at other end for storing energy therein when the steel roll-up curtain is moved away from the completely opened position. Therefore, when the electric power to the motor is faulty, the roll-up curtain can be manually opened and closed after the user makes the worm disengage the worm wheel. And, the elastic element will release the stored energy to help the user open the roll-up curtain.

### BRIEF DESCRIPTION OF THE DRAWINGS

FIG. 1 is a vertical section of the first conventional actuating mechanism of a roll-up door, which has a chain and chain disk assembly,

FIG. 2 is a partial vertical section of the first conventional actuating mechanism of a roll-up door,

FIG. 3 is a vertical section of the second conventional actuating mechanism of a roll-up door, which is equipped with a handle,

FIG. 4 is a vertical section of the actuating mechanism of a roll-up door according to the present invention,

FIG. 5 is a partial vertical sectional view of the present invention,

FIG. 6 is a sectional view of the first preferred embodiment, which is equipped with a lever, with the worm engaging the worm wheel,

FIG. 7 is a sectional view of the second embodiment, which has a chain and chain disk assembly, with the worm engaging the worm wheel,

FIG. 8 is a sectional view of the first preferred embodiment with the worm being disengaged from the worm wheel,

FIG. 9 is a sectional view of the second preferred embodiment with the worm being disengaged from the worm wheel,

FIG. 10 is a side sectional view of the present invention, and

FIG. 11 is a side sectional view of the invention with the lever in the other position.

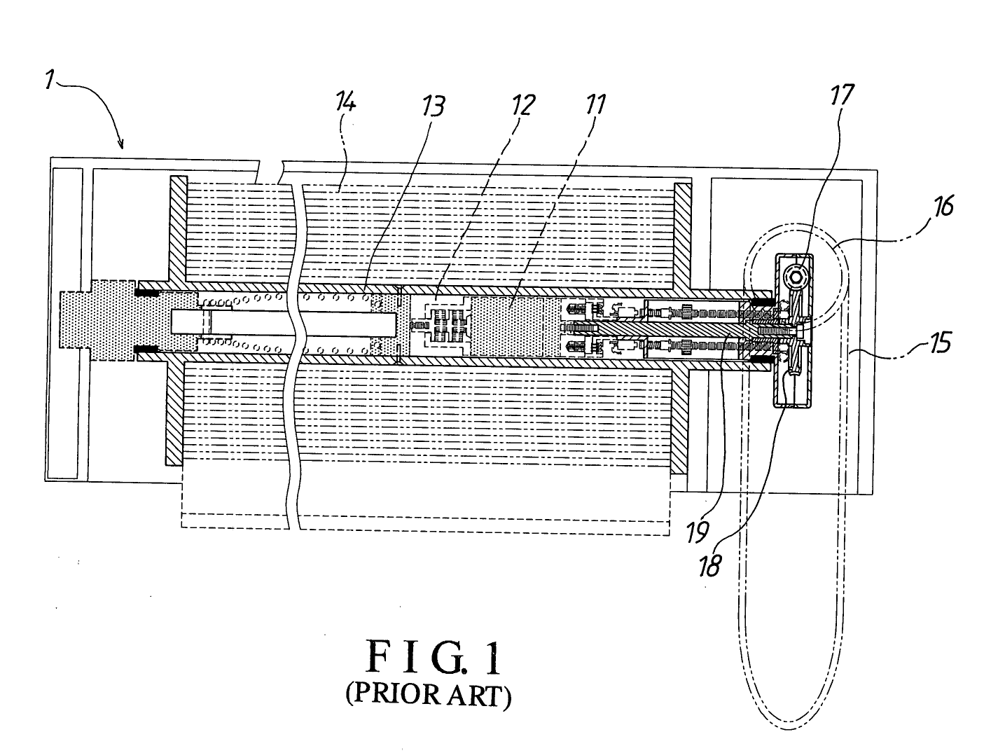

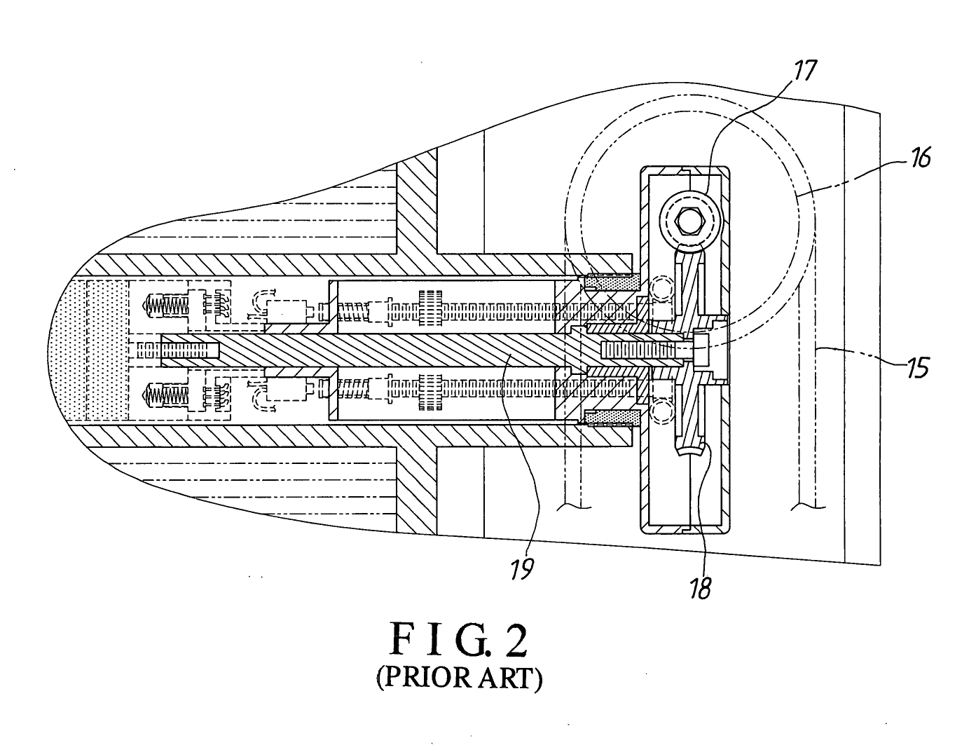

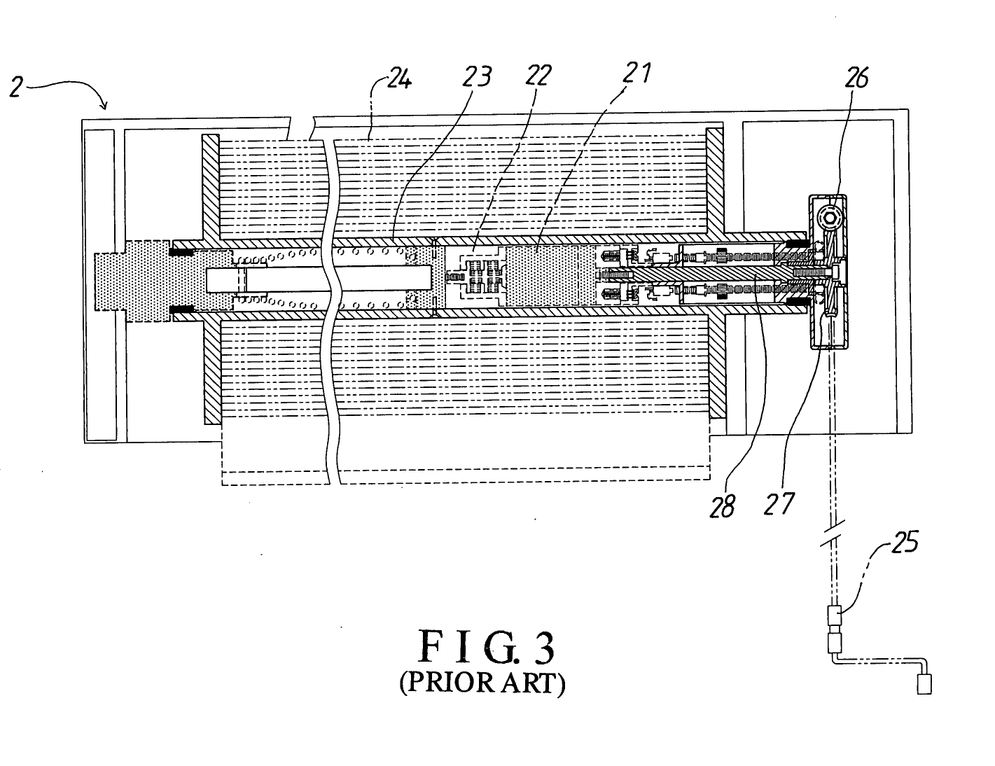

### DETAILED DESCRIPTION OF THE PREFERRED EMBODIMENTS

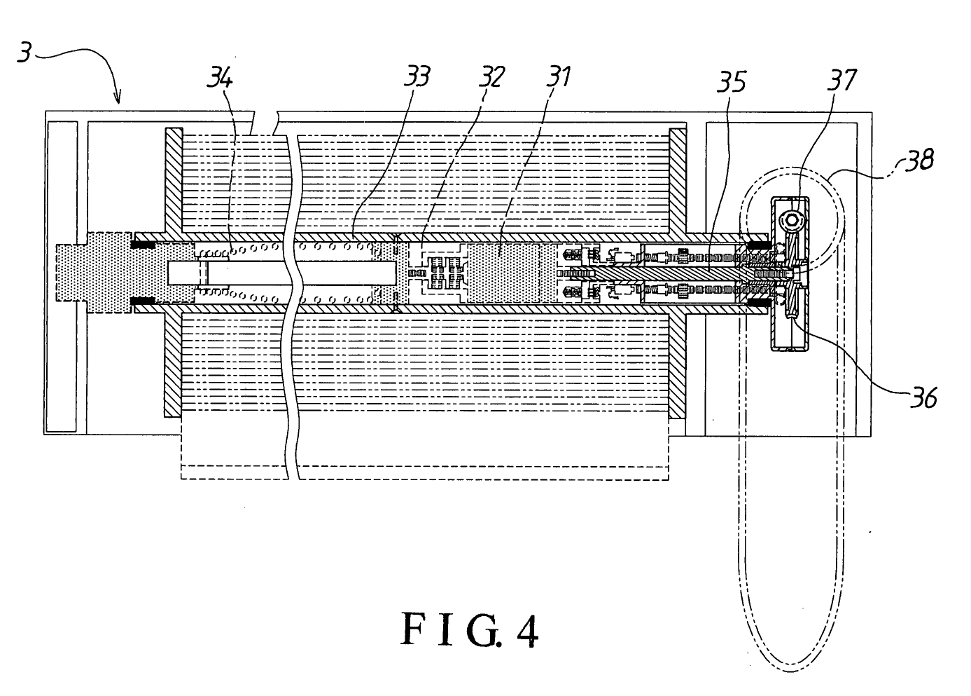

Referring to FIGS. 4 to 6, a preferred embodiment 3 of an actuating mechanism of steel roll-up doors and windows includes a motor 31, a transmission unit 32, a tube member 33, an elastic element 34, a connecting shank 35, a worm wheel 36, a worm 37, a manual control unit 38, and a securing unit 39.

The transmission unit 32 is securely connected to an output shaft of the motor 31 as well as the tube member 33. The worm 37 has a toothed side 371 facing in one direction, and a straight side 372 facing in an opposite direction to that of the toothed side 371; thus, the worm 37 can engage the worm wheel 36 at the toothed side 371, and it will be disengaged from the worm wheel 36 when facing the worm wheel 36 at the straight side 372. The connecting shank 35 is securely joined to a main body of the motor 31 at one end, and an axis of the worm wheel 36 at the other end. The elastic element 34 is fixed at one end, and joined to the transmission unit 32 at the other end. A steel roll-up curtain is connected to the tube member 33 such that the transmission unit 32 and the tube member 33 will be turned together, and position of the roll-up curtain will be changed when the electric motor 31 is activated.

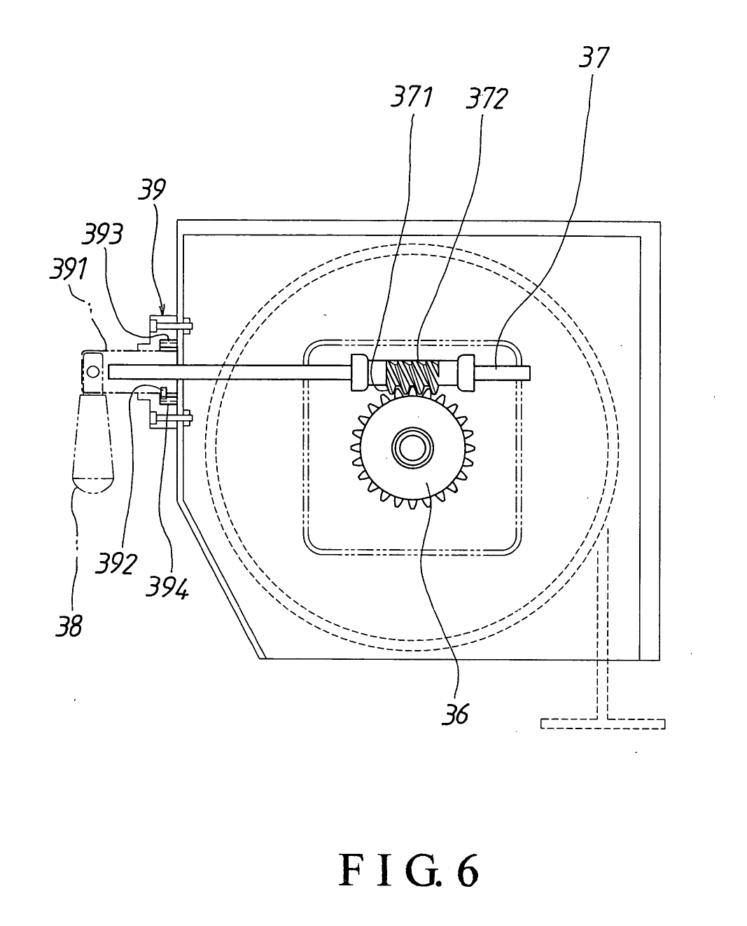

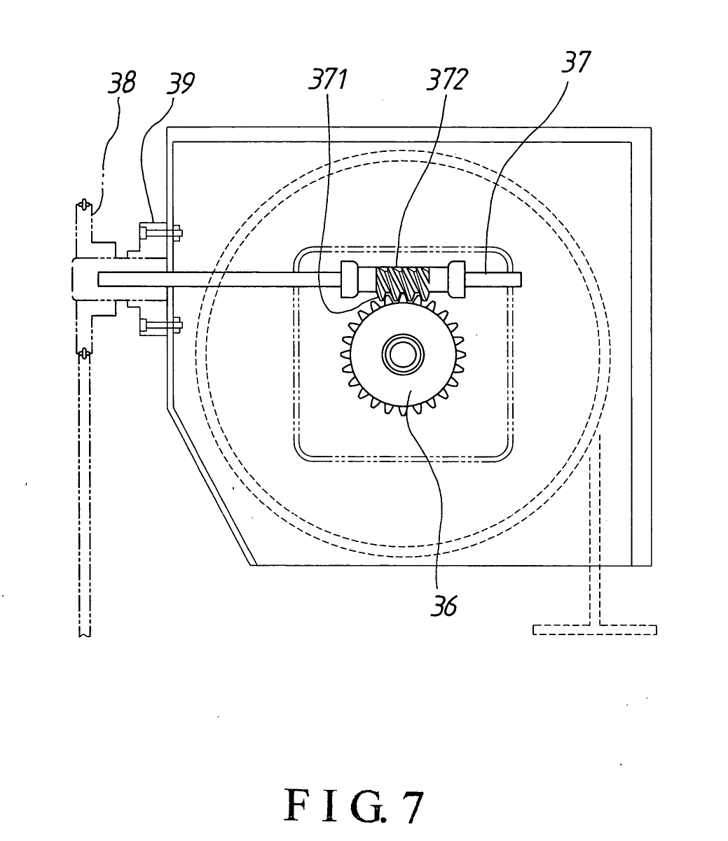

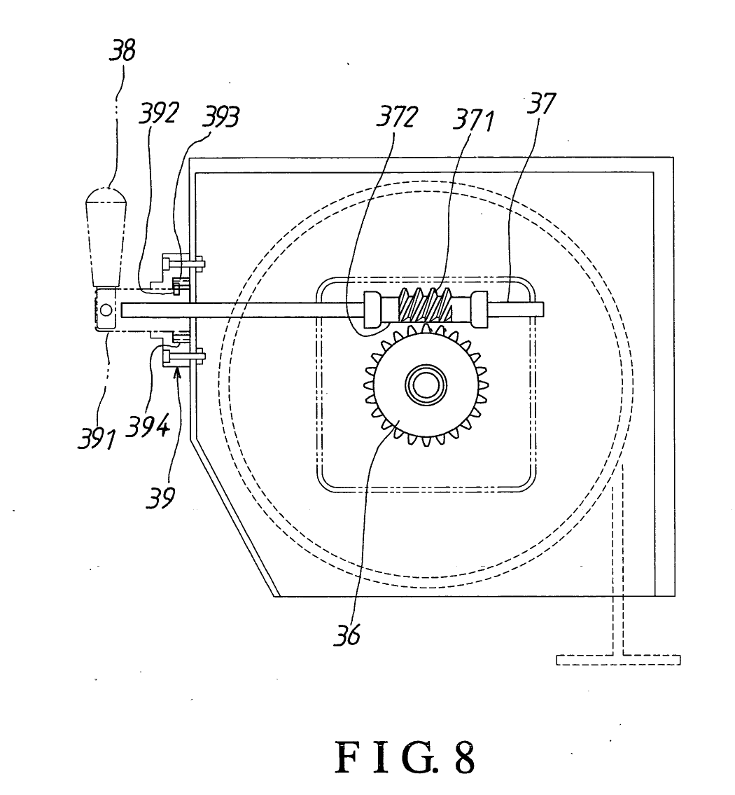

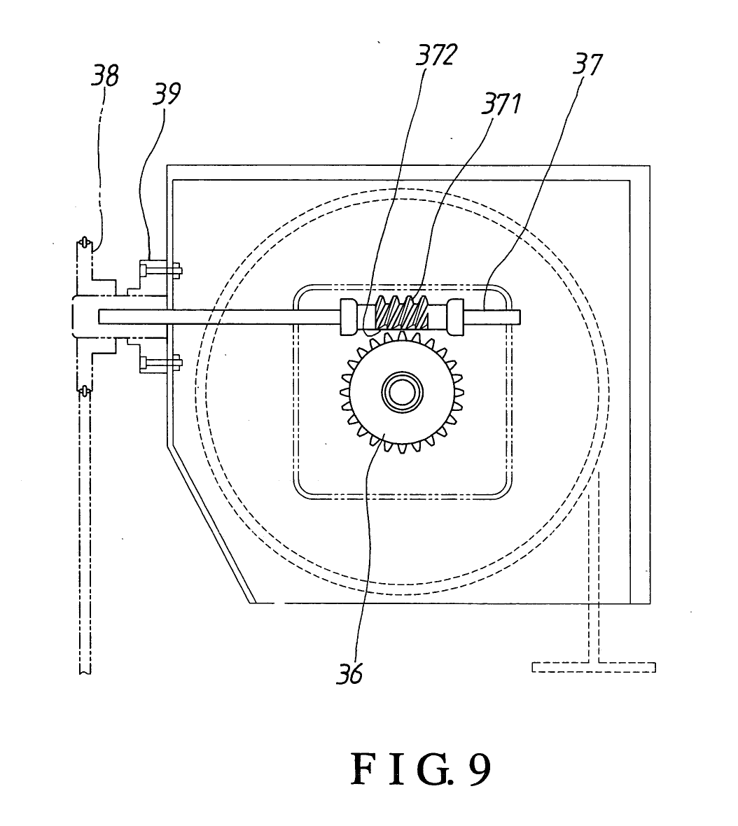

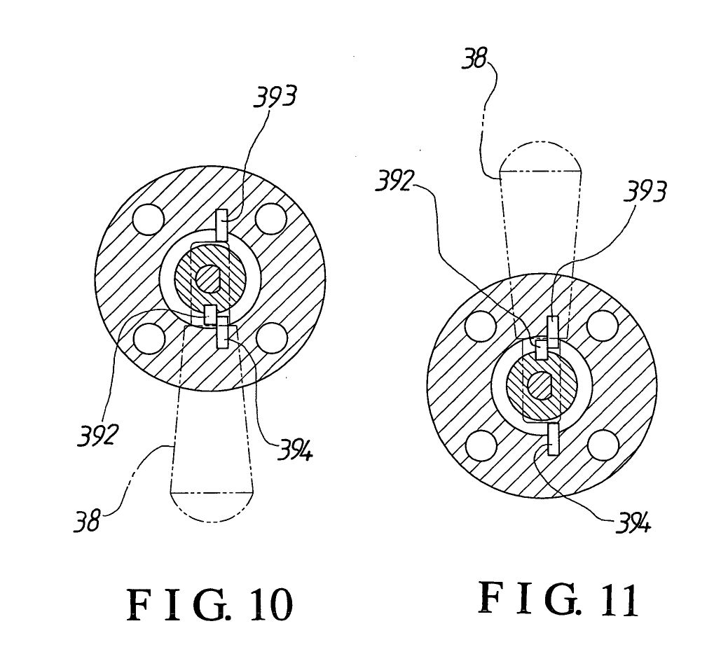

The securing unit 39 includes a horizontal bar 391, a stopping block 392 secured on the horizontal bar 391, and upper and lower fixed blocks 393 and 394. The horizontal bar 391 is securely joined to one end of the worm 37 with the stopping block 392 facing in the same direction as the toothed side 371 of the worm 37. The upper fixed block 393 is secured near to an upper side of the horizontal bar 391, and the lower fixed block 394 is secured near to a lower side of the horizontal bar 391; thus, the worm 37 will be immobilized, and engage the worm wheel 36 to prevent the worm wheel 36 from turning when the stopping block 392 is engaged with the lower fixed block 394, as shown in FIGS. 6, 7, and 10. And, the worm 37 won't be engaged with the worm wheel 36, and the worm wheel 36 is allowed to turn when the stopping block 392 is engaged with the upper fixed block 393, as shown in FIGS. 8, 9, and 11. Thus, the worm wheel 36, the connecting shank 35, and the main body of the motor 31 will be immobilized when the stopping block 392 is engaged with the lower fixed block 394.

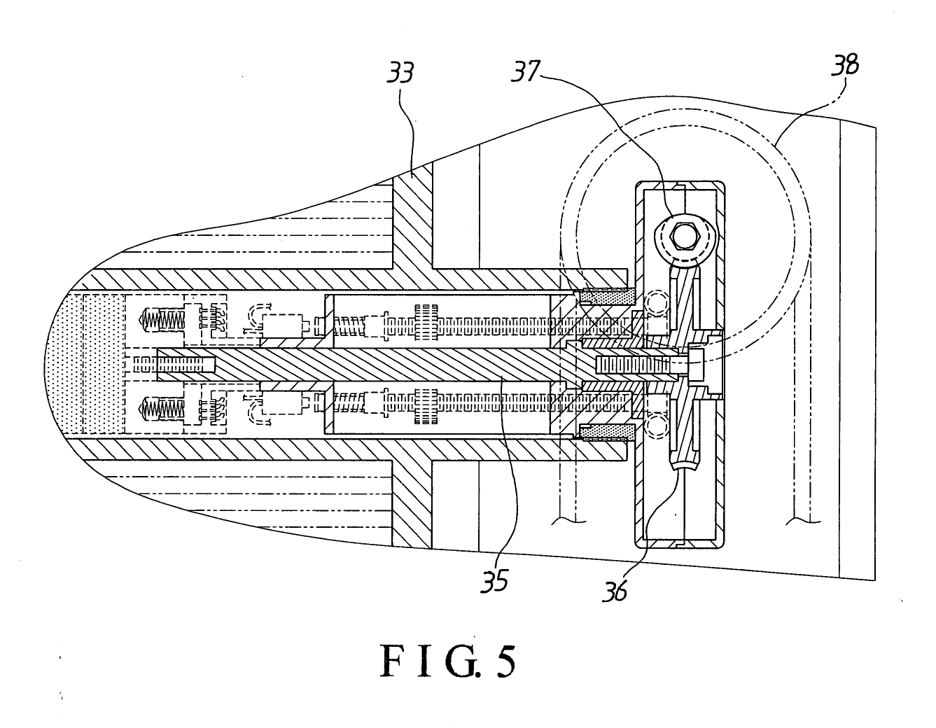

The manual control unit 38 is joined to the horizontal bar 391 of the securing unit 39 such that the horizontal bar 391 and the worm 37 will be angularly displaced together when the control unit 38 is operated. A lever is used as the manual control unit 38 in a first preferred embodiment of the invention (as shown in FIGS. 6 and 8), and a chain and chain disk assembly is used as the manual control unit 38 in a second preferred embodiment of the invention (as shown in FIGS. 4 and 5).

Referring to FIGS. 4, 6, 7, and 10, when the worm 37 is engaged with the worm wheel 36, and the motor 31 is activated, the transmission unit 32 and the tube member 33 will be turned together with the output shaft of the motor 31, and in turn position of the roll-up curtain is changed; the elastic element 34 will be turned so as to have energy stored therein when the roll-up curtain is moved downwards away from the completely opened position.

The roll-up curtain will have to be opened with hands instead if the power supply to the motor 31 is faulty. Referring to FIGS. 8, 9, and 11, the manual control unit 38 is first operated to disengage the worm 37 from the worm wheel 36 such that the tube member 33, the transmission unit 32, the main body of the motor 31, the connecting shank 35, and the worm wheel 36 are free to turn together, allowing the user to move the roll-up curtain with his/her hands; the elastic element 34 will release the stored energy to help the user move the roll-up curtain from the closed position towards the opened position.

From the above description, it can be easily seen that because of the actuating mechanism of the present invention, a person is allowed to open the roll-up curtain rapidly with his/her hands when power supply to the motor is faulty, preventing casualty from happening in the event of an emergency such as fire.

What is claimed is:

1. An improvement on an actuating mechanism of steel roll-up doors and windows, comprising
a motor;
a tube member having a steel roll-up curtain connected thereto; the tube member being turnable in a first direction for winding the steel roll-up curtain around it, and turnable in a second direction for unwinding the steel roll-up curtain;
a transmission unit; the transmission unit being securely connected to an output shaft of the motor as well as the tube member;
a connecting shank securely joined to a main body of the motor at a first end thereof; the connecting shank having a second end;
a worm wheel securely joined to the second end of the connecting shank at an axis thereof;
a worm arranged next to the worm wheel; the worm having a toothed side facing in one direction for engaging the worm wheel; the worm having a straight side facing in an opposite direction to that of the toothed side; the worm being not going to engage the worm wheel when facing the worm at the straight side thereof; and
an elastic element; the elastic element being fixed at one end, and securely joined to the transmission unit at other end for storing energy therein when the steel roll-up curtain is moved away from a completely opened position;
whereby when power supply to the motor is faulty, the steel roll-up curtain can be manually opened and closed after the worm has been turned to such a position as not to engage the worm wheel.

2. The actuating mechanism of steel roll-up doors and windows as claimed in claim 1, wherein a manual control unit is connected to the worm for angularly displacing the worm with.

3. The actuating mechanism of steel roll-up doors and windows as claimed in claim 2, wherein the manual control unit is a chain and chain disk assembly.

4. The actuating mechanism of steel roll-up doors and windows as claimed in claim 2, wherein the manual control unit is a lever.

5. The actuating mechanism of steel roll-up doors and windows as claimed in claim 1 further having a securing unit for the worm; the securing unit including:
a horizontal bar securely joined to one end of the worm;
a stopping block secured on the horizontal bar, and
first and second fixed blocks fixed in position on two sides of the horizontal bar for allowing the stopping block to be selectively engaged with;
the worm being going to be engaged with the worm wheel to prevent the worm wheel from turning when the horizontal bar is moved to such a position that the stopping block is engaged with the second fixed block to immobilize the worm; the worm being going to be disengaged from the worm wheel when the horizontal bar is moved to such a position that the stopping block is engaged with the first fixed block to immobilize the worm.
